(19) United States
(12) Patent Application Publication
(10) Pub. No.: US 2009/0021451 A1
(43) Pub. Date: Jan. 22, 2009

(54) SCANNER APPARATUS AND INFORMATION DISPLAY SYSTEM PROVIDED WITH THE SAME

(76) Inventor: Yasuhiro Suto, Nara-shi (JP)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/166,508

(22) Filed: Jul. 2, 2008

(30) Foreign Application Priority Data
Jul. 17, 2007 (JP) 2007-186017

(51) Int. Cl. G06T 13/00; H04N 1/04

(52) U.S. Cl. 345/30; 358/474

(57) ABSTRACT

The scanner apparatus which can be stored in the pedestal supporting the display apparatus has slide members on its side, which are engaged with slide members provided on the pedestal, and the apparatus can be stored so as to be drawn out freely from the pedestal. In addition, the upper unit incorporating an automatic document feeder is rotatable upward on a rotary shaft provided on the side of the apparatus in a state of being drawn out from the pedestal, and when a jam occurs, the scanner apparatus is drawn out from the pedestal to rotate the upper unit upward and open a part of a sheet feeding path, and thereby a jammed sheet can be removed.

### CROSS-NOTING PARAGRAPH

This Non-provisional application claims priority under 35 U.S.C. §119(a) on Patent Application No. 2007-186017 filed in JAPAN on Jul. 17, 2007, the entire contents of which are hereby incorporated herein by reference.

### FIELD OF THE INVENTION

The present invention relates to a scanner apparatus which is suitable for being disposed below a large-sized display apparatus supported by a stand, and an information display system provided with the scanner apparatus.

### BACKGROUND OF THE INVENTION

In recent years, as electronic conference systems, an electronic conference system is proposed, that conference contents are directly written on a large-sized liquid crystal screen in a free format using input means such as a touch pen and all of the conference contents are converted into electronic information, so that the document management, distribution to the participants, and processing of the contents, after the conference, are easily performed.

Further, a system form is also provided, that a scanner apparatus is connected to a display apparatus through a network to convert the information included in an additional sheet into electronic information and capture in the display apparatus during a conference.

However, since the scanner apparatus is not always necessary in a presentation, when holding a conference using the display apparatus, the scanner apparatus connected to the display apparatus can be obstructive by contraries. Then, the scanner apparatus is considered to be disposed in the lower side of a pedestal which supports the display apparatus. This requires making the structure compact, for example, by storing a paper feed tray which protrudes to outside of a housing of the scanner apparatus in the housing of the apparatus, as seen in Japanese Laid-Open Patent Publication No. 6-9064.

However, even when the scanner apparatus is made compact so as to be able to be disposed in the lower side of the display apparatus, there is another problem that, in a case where a jam occurs during the sheet transport when reading the sheet using the scanner apparatus, it is very difficult to remove the jammed sheet.

### SUMMARY OF THE INVENTION

An object of the present invention is to provide an information display system, in which, when a jam occurs in a scanner apparatus which is stored in a lower part of a display apparatus, a jammed sheet can be easily removed.

Another object of the present invention is to provide an information display system, comprising: a display apparatus in which a display portion is supported by a pedestal; and a scanner apparatus stored in a lower part of the pedestal and connected to the display apparatus, which has an upper unit in which an automatic document feeder is stored and a lower unit in which an image reading device is stored, wherein the scanner apparatus is provided so as to be drawable by slide members which are provided in the pedestal and the scanner apparatus, moreover, the upper unit is provided so as to be rotatable upward in a state where the scanner apparatus is drawn out from the pedestal, and the upper unit is rotated upward so that a part of a sheet feeding path of the automatic document feeder is opened.

Another object of the present invention is to provide an information display system, wherein the slide members comprise a rail and a sliding member which slides on the rail with enclosing the rail.

Another object of the present invention is to provide an information display system, wherein in a direction where the sheet feeding path is opened by rotating the upper unit of the scanner apparatus upward, a power switch of the display apparatus is disposed.

Another object of the present invention is to provide an information display system, wherein in a direction where the sheet feeding path is opened by rotating the upper unit of the scanner apparatus upward, an operation input portion of the display apparatus is disposed.

Another object of the present invention is to provide an information display system, wherein in a direction where the sheet feeding path is opened by rotating the upper unit of the scanner apparatus upward, a touch pen holder is disposed.

Another object of the present invention is to provide an information display system, wherein the display apparatus includes a touch panel.

Further, another object of the present invention is to provide a scanner apparatus in the information display system.

### BRIEF DESCRIPTION OF THE DRAWINGS

FIG. 1 is a diagram showing an overview of a display apparatus and a pedestal used in an information display system of the present invention;

FIGS. 2A and 2B are diagrams illustrating a falling preventive leg of the pedestal shown in FIG. 1;

FIG. 3 is a diagram showing a scene using the information display system;

FIG. 4 is a structural block diagram of the information display system;

FIGS. 5A and 5B are diagrams showing a state of the information display system when viewed from the side face;

FIG. 6 is a diagram illustrating a state using an electronic equipment (a printer) in the information display system;

FIGS. 7A and 7B are illustrative views of a scanner apparatus used in the information display system;

FIG. 8 is a schematic view showing an inner part of the scanner apparatus;

FIG. 9 is a diagram showing a width guide rack mechanism of the scanner apparatus; and

FIG. 10 is a diagram showing a state where auxiliary trays of the scanner apparatus are drawn out.

### PREFERRED EMBODIMENTS OF THE INVENTION

Now, referring to the accompanying drawings, embodiments of the present invention will hereinafter be described.

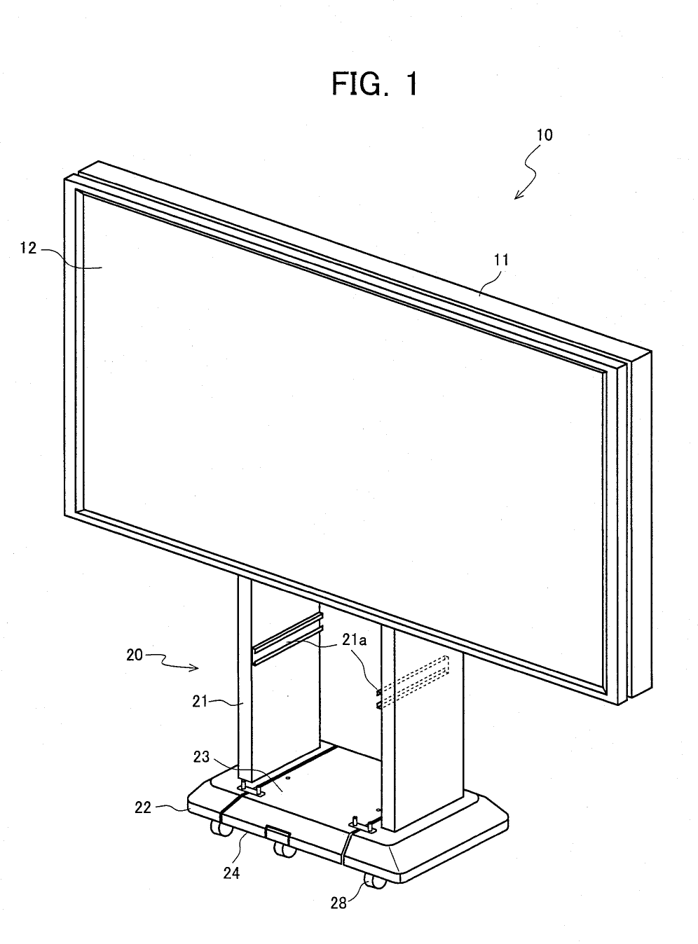

FIG. 1 is a diagram showing an overview of a pedestal (stand) on which electronic equipment such as a scanner apparatus and a printer can be disposed in the lower side, and a display apparatus supported by the pedestal.

A pedestal 20 which supports a display apparatus 10 includes a pair of legs 21, a base 22, and a slidable mounting base 23 which also serves as a falling preventive leg 24, and casters (wheels for moving) 28 are provided on the bottom of the base 22 and the falling preventive leg 24.

Rail portions 21a are provided in the insides of right and left legs 21 for enabling to store a scanner apparatus 50, which will be described below, so as to be drawn out freely.

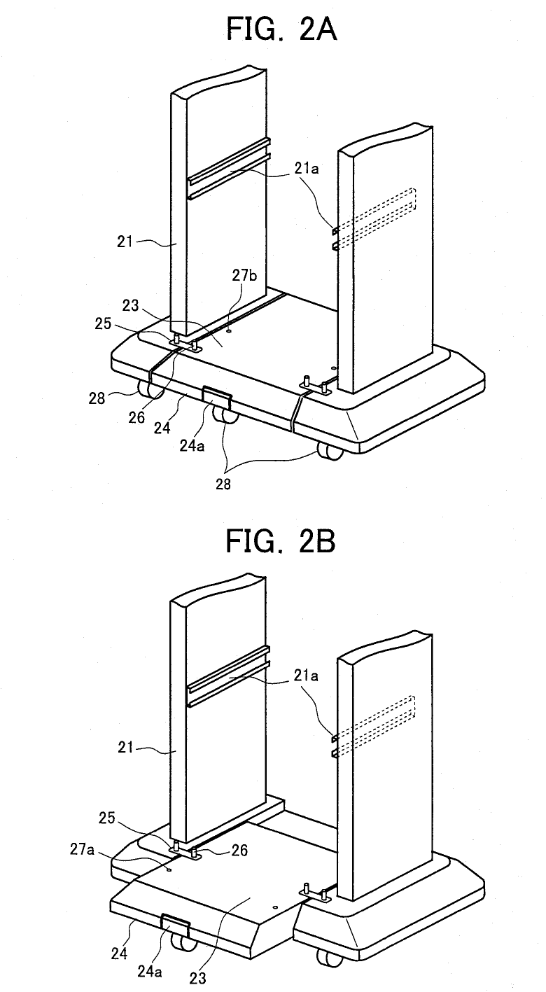

In order to make the falling preventive leg 24 in the falling preventive state by pulling out from the base 22, fixing pins 26 are drawn out in the state of FIG. 2A, followed by grasping and pulling a releasing lever 24a to pull out the falling preventive leg 24, then fixing holes 27b provided on the mounting base 23 are adjusted to positions of fixing fittings 25 to insert the fixing pins 26, so as to be in the state shown in FIG. 2B.

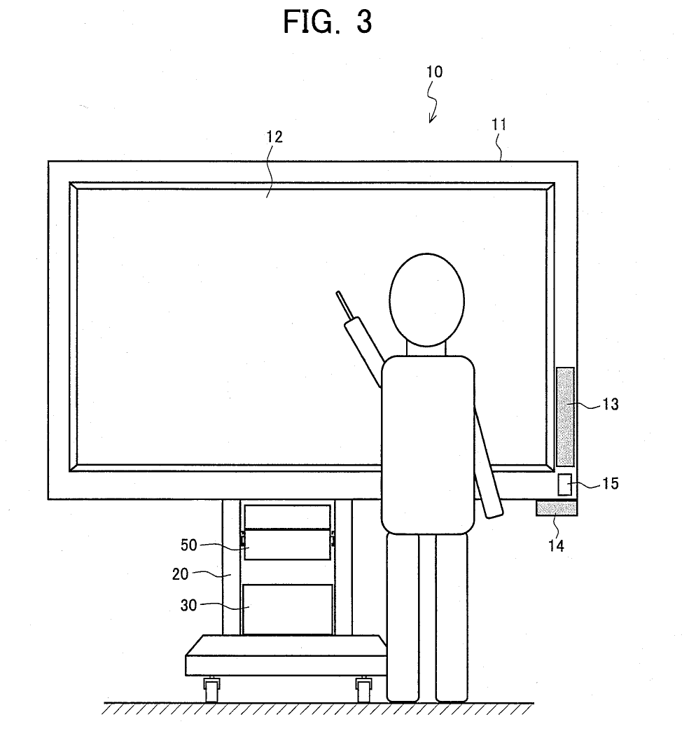

By storing electronic equipment in the pedestal 20 as described above, the printer 30 and the scanner apparatus 50, which are not used at all times, can be stored in the lower side of the pedestal 20, and a user who gives a presentation as is operating the display apparatus 10 is not disturbed, as shown in FIG. 3.

Note that, in consideration of the operability for a user who is leading a conference, an operation input portion 13 used for setting a display of an initial screen etc., a touch pen holder 14 in which a touch pen is stored, and a power switch 15 are provided in the right end in the display apparatus shown in FIG. 3.

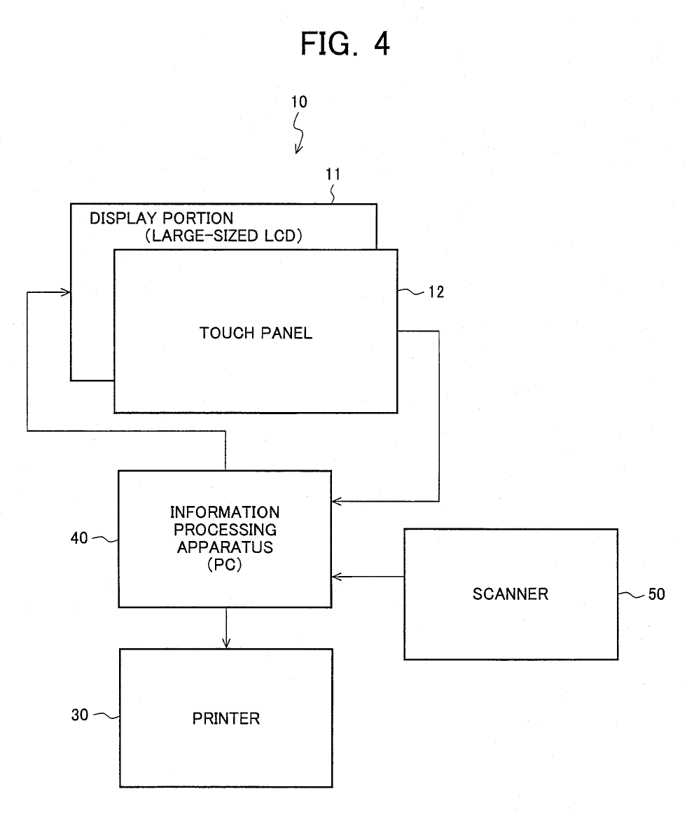

FIG. 4 is an overall block diagram of the information display system according to the present invention. The display apparatus 10 in an information display system 100 is made of a display portion 11 and a touch panel 12 provided on a front face of the display portion 11, and is able to detect a coordinate of the touched part and to display various information based on a touch operation. The display apparatus 10 is connected to an information processing apparatus (PC) 40, and outputs display information to the display apparatus 10. The printer 30 is an apparatus for printing out the display information, and corresponds to electronic equipment in the information display system of the present invention. The scanner apparatus 50 converts the information read from a sheet original into electronic information.

The read data may be displayed by the display apparatus 10 through the information processing apparatus (PC) 40, or when the display apparatus 10 has a function of the image processing, the data may be directly transported from the scanner apparatus 50 to the display apparatus 10.

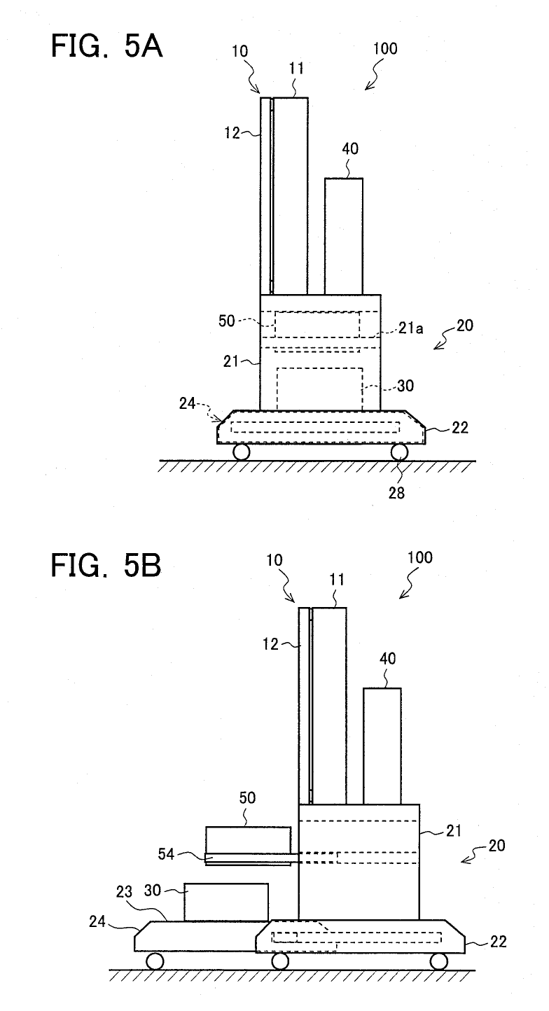

FIGS. 5A and 5B are diagrams showing a state of the information display system according to the embodiment of the present invention when viewed from the side face. In the present embodiment, the information processing apparatus 40 is disposed in the rear face of the display apparatus 10, and FIG. 5A shows a state where the falling preventive leg 24 on which the printer 30 is placed and the scanner apparatus 50 are stored, respectively. FIG. 5B shows a state where the printer placed on the mounting base 23 and the scanner apparatus 50 are drawn out, and slide members 54 which slide on the rail portions 21a are attached to both outsides of the scanner apparatus 50, as described below.

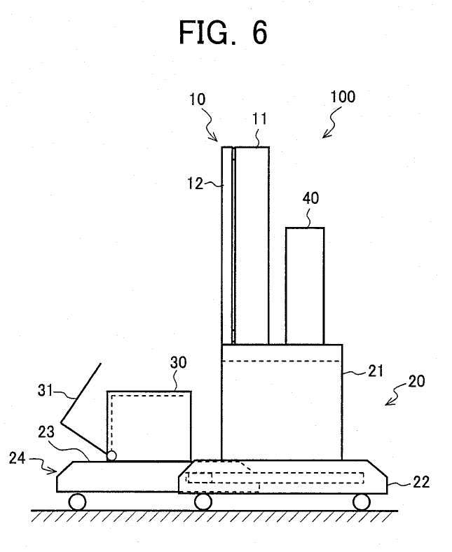

In the printer 30 as well, by pulling out the printer 30 together with the mounting base 23 as shown in FIG. 6, a cover 31 is opened and the replacing of a developer cartridge etc., can be performed.

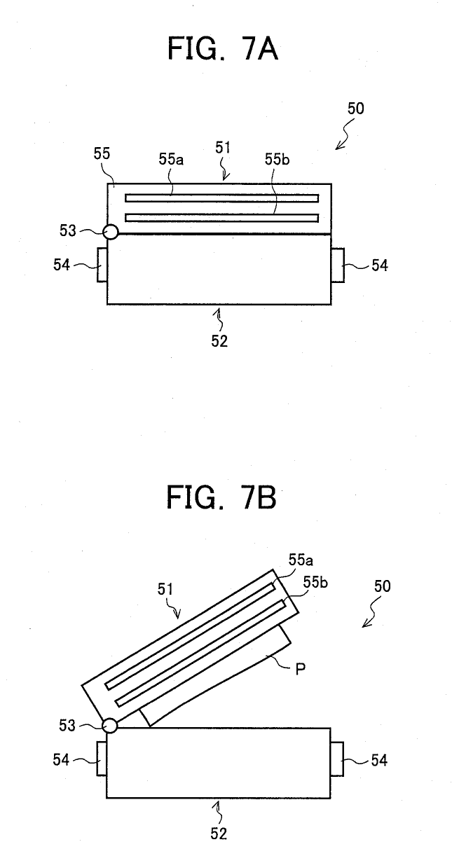

FIGS. 7A and 7B are front views of the scanner apparatus in the embodiment of the present invention, and, as shown in FIG. 7A, the scanner apparatus 50 is configured so that an upper unit 51 incorporating an automatic document feeder is rotatable upward on a rotary shaft 53 which is provided in the left side part.

The above slide members 54 are provided on both sides of the apparatus, and an original insertion port 55a and an original discharge port 55b are formed on a front face portion 55. The slide members 54 are provided so as to slide with respect to the rail portions 21a, and specifically, the slide members 54 include a rail portion 21a and a sliding member which slides on the rail portion 21a with enclosing the rail portion 21a.

When a jam occurs during the sheet transport, the scanner apparatus 50 is drawn out and the upper unit 51 is rotated upward as shown in FIG. 7B to open a part of the sheet feeding path, and thereby a jammed original P can be easily removed.

According to the scanner apparatus 50 of the above embodiment, the scanner apparatus 50 is used in the state of being stored in the pedestal after setting an original, and when a jam occurs, the scanner apparatus 50 is slid and drawn out from the pedestal 20, and thereby a jammed original can be easily removed.

In the case of the large-sized display as shown in FIG. 3, the direction in which the upper unit 51 is rotatable (a direction in which a feeding path of a jammed sheet is opened) is made to be a direction where the operation input portion 13, the touch pen holder 14, and the power switch 15 etc., are disposed, and thereby the operability and workability for a user who is leading a conference are improved.

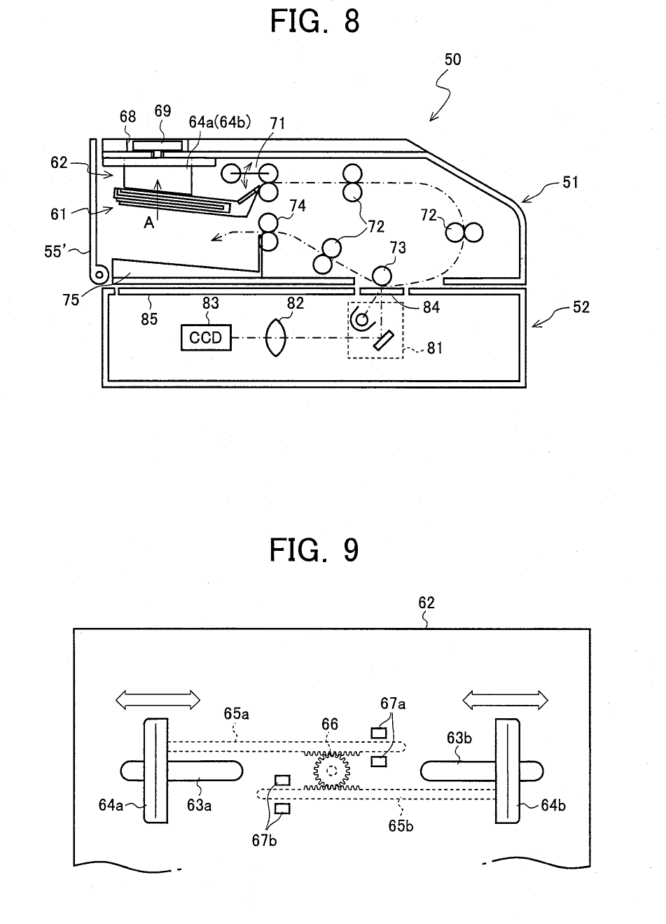

FIG. 8 is a diagram schematically showing the inside of a housing of the scanner apparatus, where the scanner apparatus 50 is roughly divided into the upper unit 51 constituting an automatic document feeder and a lower unit 52 constituting an image reading device.

The upper unit 51 includes a paper feed tray 61 on which an original bundle made of a plurality of originals is stacked, a width guide rack mechanism 62 having a function of detecting a size of a sheet original, a paper feed roller 71 for taking out sheet originals set on the paper feed tray 61 sheet by sheet, a plurality of feed rolls 72 for feeding the taken sheet original to the downstream side, a press-contact roller 73 for putting a sheet original in press-contact with a platen glass, a paper discharge roller 74 for discharging an original, the reading of which is finished, and a paper discharge tray 75.

The width guide rack mechanism 62 is provided above the paper feed tray 61 as shown in the figure. In addition, a recessed portion 68 disposed on the top face of the apparatus is provided with an operation member 69 so that width guide members 64a and 64b can be operated from outside of the apparatus, and the operation member 69 penetrates slot guides 63a and 63b (FIG. 9) to be connected to the width guide members 64a and 64b. Such a structure enables to make the scanner apparatus more compact.

The lower unit 52 includes a scan unit 81 which has an exposure lamp for exposing an image surface of an original and a mirror for changing a reflected image from the original in a predetermined direction, an image formation lens 82 for optically reducing a light image obtained from the mirror of the scan unit 81, a CCD (charge coupled device) image sensor 83 for sequentially applying photoelectric conversion to the light image formed by the image formation lens 82 to output as en electric signal, a first platen glass 84 for forming an aperture for light to read an original transported by the document feeder in the upper unit 51, and a second platen glass 85 on which an original, an image of which is to be read, is placed in a stationary state. The image signal obtained by the CCD image sensor 83 is transmitted to a signal processing circuit (not shown).

FIG. 9 shows the structure of the width guide rack mechanism for detecting a size of an original stacked on the paper feed tray 61. The figure schematically shows the structure when viewed from the position of the paper feed tray 61 (an arrow A of FIG. 8), and the width guide rack mechanism 62 is provided above the paper feed tray 61. The right and left width guide members 64a and 64b are provided so as to be movable in a lateral direction by slot guides 63a and 63b and slidable by the operation member 69 (FIG. 8) which is attached from outside of the apparatus. Each of the width guide members 64a and 64b is attached with racks 65a and 65b which are engaged with a pinion, respectively, and sensors 67a and 67b are disposed near tip parts of the racks 65a and 65b.

Thereby, when the width guide members 64a and 64b are slid in the lateral direction in accordance with a size of an original, the sensors 67a and 67b detect positions (moving amount) of the racks 65a and 65b and thereby the size of the original is detected.

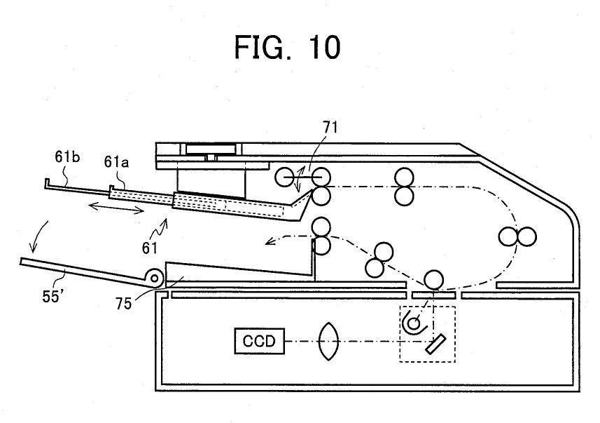

As shown in FIG. 10, the paper feed tray 61 includes auxiliary trays 61a and 61b, in which when an original has a size such that the original can not be stored in the apparatus, a front door 55′ is opened and the auxiliary trays 61a and 61b are drawn out, so as to be applicable to a large-sized original. In addition, the front door 55, also serves as a discharge tray when it is opened. Further, the front door 55′ in the present embodiment may be also provided with an original insertion port and an original discharge port as the scanner apparatus shown in FIG. 7.

According to the present invention, following effect can be obtained.

According to the present invention, even when a jam occurs at the time of using a scanner apparatus in a state of being stored in a pedestal which supports a large-sized display apparatus, the scanner apparatus is slid and drawn out and an upper unit is rotated upward to open a part of a sheet feeding path, and thereby it is possible to remove a jammed sheet easily.

Further, according to the present invention, in the position where a user uses an information display system to carry out a presentation, an operation of removing a jammed sheet can be performed and the workability is improved.

1. An information display system, comprising:
a display apparatus in which a display portion is supported by a pedestal; and
a scanner apparatus stored in a lower part of the pedestal and connected to the display apparatus, which has an upper unit in which an automatic document feeder is stored and a lower unit in which an image reading device is stored, wherein
the scanner apparatus is provided so as to be drawable by slide members which are provided in the pedestal and the scanner apparatus, moreover, the upper unit is provided so as to be rotatable upward in a state where the scanner apparatus is drawn out from the pedestal, and the upper unit is rotated upward so that a part of a sheet feeding path of the automatic document feeder is opened.

2. The information display system as defined in claim 1, wherein
the slide members comprise a rail and a sliding member which slides on the rail with enclosing the rail.

3. The information display system as defined in claim 1, wherein
in a direction where the sheet feeding path is opened by rotating the upper unit of the scanner apparatus upward, a power switch of the display apparatus is disposed.

4. The information display system as defined in claim 1, wherein
in a direction where the sheet feeding path is opened by rotating the upper unit of the scanner apparatus upward, an operation input portion of the display apparatus is disposed.

5. The information display system as defined in claim 1, wherein
in a direction where the sheet feeding path is opened by rotating the upper unit of the scanner apparatus upward, a touch pen holder is disposed.

6. The information display system as defined in claim 1, wherein
the display apparatus includes a touch panel.

7. The scanner apparatus in the information display system as defined in claim 1.
